(19) United States
(12) Patent Application Publication
(10) Pub. No.: US 2026/0152434 A1
(43) Pub. Date: Jun. 4, 2026

(54) INTERFERENCE STRUCTURING OF GLASS SURFACES

(71) Applicant: 4JET microtech GmbH, Alsdorf (DE)

(72) Inventors: Shubham Dhar DWIVEDI, Aachen (DE); Tobias DYCK, Aachen (DE)

(21) Appl. No.: 18/546,262

(22) PCT Filed: Dec. 15, 2021
(86) PCT No.: PCT/EP2021/085973

§ 371 Date: Aug. 11, 2023

(30) Foreign Application Priority Data
Mar. 16, 2021 (DE) 10 2021 106 412.0

(51) Int. Cl. C03C 23/00

(52) U.S. Cl. CPC C03C 23/0025

(57) ABSTRACT

Disclosed is a method comprising: generating an interference pattern on a glass surface to thereby process the glass surface, wherein the interference pattern is generated by a laser radiation of a CO2 laser. Further disclosed is a corresponding surface processing device and a corresponding use of an interference pattern of a CO2 laser.

This application is the U.S. national phase of International Application No. PCT/EP2021/085973 filed 15 Dec. 2021 which designated the U.S. and claims priority to German Patent Application No. 10 2021 106 412.0 filed 16 Mar. 2021, the entire contents of each of which are hereby incorporated herein by reference.

### TECHNICAL FIELD

The present disclosure relates to the field of processing of glass surfaces.

### BACKGROUND

It is known from practice to process glass surfaces by means of short laser pulses. For example, an article “Microfabrication and Surface Functionalization of Soda Lime Glass through Direct Interference Patterning” in Nanomaterials 2021, 11, 129, discloses the use of short pulse lasers with 12 ps or 70 ps pulse duration at a wavelength of 532 nm.

### SUMMARY

In view of the situation described above, there may be a need for an improved technology that allows processing of glass surfaces.

This need may be met by the independent claims. Advantageous embodiments are indicated in the dependent claims.

In accordance with a first aspect of the subject matter disclosed herein, a method is provided.

According to an embodiment of the first aspect, a method is provided, the method comprising: generating an interference pattern on a glass surface to thereby process the glass surface; wherein the interference pattern is generated by a laser radiation of a CO2 laser.

In accordance with a second aspect of the subject matter disclosed herein, a surface processing device is provided.

According to an embodiment of the second aspect, a surface processing device is provided, the surface processing device comprising: an object receptacle for accommodating an object having a glass surface; an optical arrangement for receiving laser radiation of a CO2 laser, the optical arrangement being adapted to generate an interference pattern on the glass surface from the laser radiation to thereby process the glass surface.

In accordance with a third aspect of the subject matter disclosed herein, there is provided a use of an interference pattern of a CO2 laser.

According to an embodiment of the third aspect, a use of an interference pattern of a CO2 laser for changing a surface property of a glass surface is provided.

### DESCRIPTION OF EXEMPLARY EMBODIMENTS

A method according to embodiments of the subject matter disclosed herein comprises generating an interference pattern on a glass surface to thereby process the glass surface, wherein the interference pattern is generated by a laser radiation of a CO2 laser.

Similarly, a surface processing device according to embodiments of the objects disclosed herein for a glass surface (i.e., a surface formed of a glass) comprises an optical arrangement for receiving laser radiation from a CO2 laser, the optical arrangement being adapted to generate an interference pattern on the glass surface from the laser radiation to thereby process the glass surface.

Similarly, a use according to embodiments of the subject matter disclosed herein comprises a use of an interference pattern of a CO2 laser for changing a surface property of a glass surface.

At least some of the aspects and embodiments of the subject matter disclosed herein are based on the inventors' recognition that interference patterning of a glass surface by means of CO2 laser radiation is possible. In contrast, known methods for laser interference patterning of glass surfaces have always used ultrashort pulses. At most, a CO2 laser has been used to heat or melt glass. The surprising usability of CO2 laser radiation for interference structuring of glass surfaces opens up new perspectives in the processing of glass surfaces. In particular, by using CO2 laser radiation and the available high power of CO2 lasers, a large area can be processed in a short time. Furthermore, laser induced periodic surface structures (LIPSS) may be avoided, which may occur within the desired interference structure and which typically have a size range of some 10 nm to some 100 nm (nm=nanometer).

According to an embodiment, adjacent intensity maxima of the interference pattern have a spacing (distance) that is in a range between 10 μm and 500 μm (μm=micrometers). For example, adjacent intensity maxima of the interference pattern may have a spacing that is between 50 μm and 150 μm, for example at (about) 100 μm.

According to an embodiment, the interference pattern has a plurality of intensity maxima. According to a further embodiment, the interference pattern has a periodic arrangement of the plurality of intensity maxima. According to a further embodiment, the intensity maxima of the plurality of intensity maxima are arranged along a line.

According to a further embodiment, the method further comprises moving the glass surface and a beam path of the laser radiation that terminates on the glass surface relative to each other, wherein the interference pattern is generated on the glass surface at least temporarily during the moving, More specifically, the moving comprises moving a beam path of the interference radiation that generates the interference pattern on the glass surface. According to an embodiment, the intensity maxima of the interference pattern extend in a transverse direction and moving the beam path of the laser radiation and the glass surface relative to each other is in a longitudinal direction that includes an angle with the transverse direction. According to an embodiment, the angle between the longitudinal direction and the transverse direction is 90 degrees. According to another embodiment, the angle may deviate from 90 degrees,

According to an embodiment, the beam path and the glass surface are moved relative to each other in at least two directions that are linearly independent of each other. For example, the movement of the beam path and the glass surface relative to each other may be meandering.

According to an embodiment, processing the glass surface with the interference pattern generates a plurality of parallel linear (line-shaped) depressions on the glass surface. According to a further embodiment, processing the glass surface with the interference pattern generates a plurality of first parallel linear depressions on the glass surface and generates a plurality of second parallel linear depressions, wherein the first linear depressions define an angle between 1 degree and 90 degrees with the second linear depressions. According to another embodiment, the first linear depressions and the second linear depressions intersect. A linear depression is also referred to herein as a groove. According to a further embodiment, processing the glass surface with the interference pattern generates at least another plurality of further parallel linear depressions. A plurality of parallel linear depressions may also be referred to as a group of parallel depressions, In this sense, according to an embodiment, processing the glass surface with the interference pattern generates at least one group, for example two, three, four or five groups of parallel depressions, each defining between them an angle between 1 degree and 90 degrees.

According to an embodiment, a glass within the meaning of the subject matter disclosed herein is a solid comprising silicon dioxide. According to an embodiment, the glass has at least partially an amorphous structure.

According to an embodiment, the glass is a quartz glass or a borosilicate glass. Hence, according to an embodiment, the glass surface is a surface of a quartz glass or a borosilicate glass.

According to an embodiment, the wavelength of the laser radiation of the CO2 laser is in a range between 9 μm and 11 μm.

According to an embodiment, the surface processing device comprises an object receptacle for accommodating an object having a glass surface. According to an embodiment, the object receptacle is adapted to accommodate an object formed of glass. According to another embodiment, the object receptacle is adapted to accommodate a glass sheet. According to an embodiment, the object receptacle is adapted to accommodate an object having dimensions ranging from 1 cm² to 10 m² (cm²=square centimeter; m²=square meter). According to an embodiment, the object receptacle is adjustable to accommodate objects having different dimensions. For example, the object receptacle may be adjustable for object dimensions of from 3 cm² to 3 m².

According to an embodiment, processing the glass surface with the interference pattern changes a surface property of the glass surface. For example, the change in a surface property may include at least one of: a change in a contact angle of the glass surface with a liquid, such as a change in a hydrophilic property of the glass surface; a change in an optical property of the glass surface, such as a change in an optical diffusion (scattering) of the glass surface; a change in a haptic property of the glass surface. According to an embodiment, processing the glass surface with the interference pattern changes the contact angle of the glass surface with water. According to a further embodiment, the change in an optical property is a change in a scattering property and/or a diffraction property of the glass surface. For example, the change in an optical property of the glass surface may be a frosting of the glass surface, such as a frosting that results in opacity (Le., frosted glass).

According to an embodiment, the change in a surface property is an anisotropic change in a surface property.

According to embodiments of the first aspect, the method is adapted to provide the functionality of one or more of the embodiments disclosed herein and/or to provide the functionality as required for one or more of the embodiments disclosed herein, in particular the embodiments of the first aspect, the second aspect, and/or the third aspect.

According to embodiments of the second aspect, the surface processing device is adapted to provide the functionality of one or more of the embodiments disclosed herein and/or to provide the functionality as required for one or more of the embodiments disclosed herein, in particular the embodiments of the first aspect, the second aspect, and/or the third aspect.

According to embodiments of the third aspect, the use is adapted to provide the functionality of one or more of the embodiments disclosed herein and/or to provide the functionality as required for one or more of the embodiments disclosed herein, in particular the embodiments of the first aspect, the second aspect, and/or the third aspect.

Exemplary embodiments of the subject matter disclosed herein are described below, with reference to, for example, a method, a surface processing device, and a use. It should be emphasized that, of course, any combination of features of various aspects, embodiments and examples is possible. In particular, some embodiments are described with reference to a method, while other embodiments are described with reference to a device. Still other embodiments are described with reference to use. However, it will be understood by those skilled in the art from the foregoing and subsequent description, claims, and drawings that, unless otherwise indicated, features of various aspects, embodiments, and examples may be combined and such combinations of features are to be considered disclosed by this application. For example, even a feature relating to a method or to a use is combinable with a feature relating to a device, and vice versa. With the disclosure of a method, an embodiment of a method or a function, one or more actuators as well as a functionality of a control device cooperating with the actuators are further to be regarded as disclosed, which are designed to execute the method or the function. Further, with the disclosure of a function of a device, a corresponding method defining the function without device features is to be considered disclosed. Further, features of an interference pattern define analogous features of a surface structure or area processed by a laser spot having the interference pattern.

Further advantages and features of the present disclosure will be apparent from the following exemplary description of presently preferred embodiments, to which, however, the present disclosure is not limited. The individual figures of the drawings of this document are to be considered merely schematic and not to scale.

### BRIEF DESCRIPTION OF THE DRAWINGS

FIG. 1 illustrates a surface processing device 100 in accordance with embodiments of the subject matter disclosed herein.

FIG. 2 illustrates an interference pattern 114 in accordance with embodiments of the subject matter disclosed herein.

FIG. 3 shows the object 104 of FIG. 1 processed with the laser radiation 110 in a top view.

FIG. 4 shows a side view of the glass surface 106 of FIG. 3.

FIG. 5 illustrates another object 204 having a processed glass surface 106 in accordance with embodiments of the objects disclosed herein.

### DETAILED DESCRIPTION

It is noted that in different figures similar or identical elements or components are provided with the same reference numerals, or with reference numerals differing only in the first digit. Such features or components which are identical or at least functionally identical to the corresponding features or components in another figure are described in detail only on their first occurrence in the following text, and the description is not repeated on subsequent occurrences of these features and components (or the corresponding reference numerals).

FIG. 1 illustrates a surface processing device 100 in accordance with embodiments of the subject matter disclosed herein.

According to an embodiment, the surface processing device 100 comprises an object receptacle 102 for accommodating an object 104. According to an embodiment, the object 104 may have a glass surface 106, i.e., a surface formed of glass. In this regard, the glass surface 106 may be formed by a glass coating applied to a body of the object 104. According to another embodiment, the object 104 is a glass body, wherein the glass surface 106 is a surface of the glass body.

According to an embodiment, the object receptacle 102 may be formed by a table on which the object 104 may be arranged, for example placed. Fixation of the object 104 with respect to the object receptacle 102 can be effected by usual measures or, for example, solely by the weight of the object 104.

According to an embodiment, the object processing device 100 comprises an optical arrangement 108. According to an embodiment, the optical arrangement 108 is configured to receive laser radiation 110 from a CO2 laser 112. According to an embodiment, the CO2 laser 112 may be part of the object processing device 100. According to another embodiment, the CO2 laser may be a separate element that is optically couplable to the object processing device 100 (more specifically, to the optical arrangement 108 of the object processing device 100).

According to an embodiment, the optical arrangement 108 is configured to generate an interference pattern 114 on the glass surface from the laser radiation 110. For example, according to an embodiment, the optical arrangement 108 is configured to split the laser radiation 110 in a known manner into two partial beams 116, 118 that interfere on the glass surface 106 to form the interference pattern 114, for example as shown in FIG. 1. In other words, according to an embodiment, the optical arrangement 108 is configured to direct the laser radiation 110 onto the glass surface 106 in the form of two interfering partial beams. According to another embodiment, the optical arrangement 108 may be configured to form three or more interfering partial beams. The at least two partial beams 116, 118 (Le., the laser radiation 110 emitted from the optical arrangement 108 forming the interference pattern 114) are also referred to herein as interference radiation 120.

According to an embodiment, the surface processing device 100 is adapted to move the interference radiation 120 and the glass surface 106 relative to each other. According to an embodiment, the surface processing device 100 comprises an actuator arrangement 122 for this purpose. According to an embodiment, the actuator arrangement 122 comprises at least one actuator, for example a first actuator 124 for moving the optical arrangement 108 and/or a second actuator 126 for moving the object receptacle 102, for example as shown in FIG. 1.

According to an embodiment, the actuator arrangement 122 is configured to move the beam path and the glass surface relative to each other in at least two directions that are linearly independent of each other. In this way, any movement in two dimensions can be realized. For example, a first actuator (for example, the first actuator 124) may be configured to move in a first direction and a second actuator (for example, the second actuator 126) may be configured to move in a second direction extending transversely (for example, perpendicularly) to the first direction. According to another embodiment, the actuator arrangement 122 is configured for movement in three dimensions.

Generally, the actuator arrangement is configured to move the interference radiation 120 and the glass surface 106 relative to each other. The moving may include at least one of the following: a linear movement of the interference radiation 120 and the glass surface 106 relative to each other; a rotation of the interference radiation 120 and the glass surface 106 relative to each other. According to another embodiment, the actuator arrangement may be an actuator arrangement of a robotic arm that supports the optical arrangement 108 (and optionally the CO2 laser 112). In either case, the CO2 laser 112 is optically coupled to the optical arrangement 108, for example via a suitable radiation path, which may include, for example, optical elements (such as optical fibers, mirrors, etc.) for guiding the laser radiation 110.

According to an embodiment, the optical arrangement 108 is formed and arranged with respect to the glass surface 106 such that adjacent intensity maxima of the interference pattern 114 have a spacing that is in a range between 10 μm and 500 μm, for example in a range between 50 μm and 150 μm.

FIG. 2 illustrates an interference pattern 114 according to embodiments of the subject matter disclosed herein. According to an embodiment, the interference pattern 114 has a plurality of intensity maxima 130, which are schematically represented by circles in FIG. 2. According to an embodiment, the spacing between two adjacent intensity maxima 130 is defined between points of maximum intensity, for example as shown at 132 in FIG. 2. According to an embodiment, the interference pattern 114 is a periodic interference pattern.

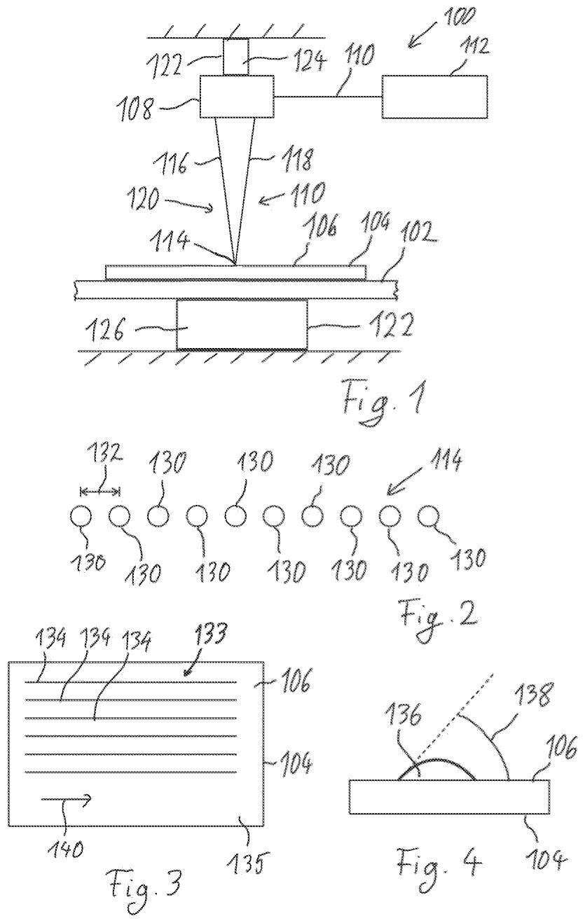

FIG. 3 shows the object 104 of FIG. 1 processed with the laser radiation 110 in a top view. According to an embodiment, a surface structure 133 is generated in the glass surface 106 of the object 104 by the interference pattern 114, which changes a physical property of the glass surface compared to the unprocessed glass surface. For example, according to an embodiment, the surface structure 133 may include a plurality of parallel grooves, some of which are designated 134 in FIG. 3.

The typical wavelength of a CO2 laser is suitable for forming the parallel grooves 134 such that a contact angle of the glass surface 106 with a liquid is changed.

FIG. 4 shows the glass surface 106 of FIG. 3 in a side view, with a drop of liquid 136, for example a drop of water, and the associated contact angle 138 drawn schematically for clarification. For example, according to an embodiment, the glass surface 106 is more hydrophilic in the area of the surface structure 133 than in an unprocessed area 135.

According to an embodiment, the surface structure 133 is formed uniaxially or the physical property of the glass surface 106 is changed uniaxially or anisotropically. For example, according to an embodiment, a drop of liquid (not shown in FIG. 3) applied to the surface structure 133 is spread along the surface structure 133 in a longitudinal direction 140, whereas spreading of the drop of liquid perpendicular to the longitudinal direction 140 is almost avoided. In other words, by processing a glass surface in accordance with embodiments of the subject matter disclosed herein, directional flow of fluids along the glass surface can be achieved. It is understood that directional flow along arbitrarily shaped paths on the glass surface can be realized by appropriately shaping the processed region.

According to a further embodiment, the surface structure is isotropic and the physical property of the glass surface 106 is isotropically changed by the surface structure. This can be achieved, for example, by a suitable interference pattern 114 or a suitable relative movement of the glass surface and the beam path (or interference pattern) with respect to each other.

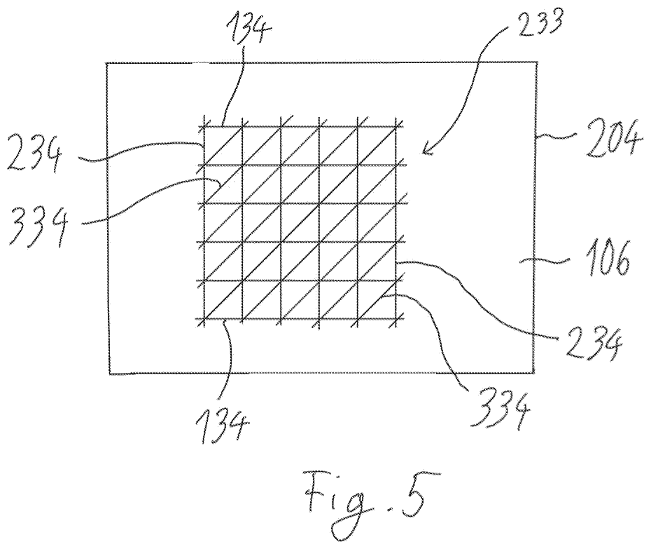

FIG. 5 illustrates another object 204 having a processed glass surface 106 in accordance with embodiments of the objects disclosed herein. According to an embodiment, the surface structure 233 includes a plurality of first parallel grooves 134, a plurality of second parallel grooves 234 arranged perpendicularly with respect to the first parallel grooves 134, and a plurality of third parallel grooves 334 arranged obliquely with respect to the first parallel grooves 134 and the second parallel grooves 234, for example as shown in FIG. 5.

A plurality of parallel grooves is also referred to herein as a set of parallel grooves. Generally, according to an embodiment, the surface structure has a plurality of sets of parallel grooves running transversely to each other, In this way, for example, a diffuser disk can be realized which diffuses incident light, for example, to influence the illuminated solid angle.

According to another embodiment, the surface structure 133, 233 implements a diffraction grating, for example a two-dimensional diffraction grating or a three-dimensional diffraction grating.

It is understood that the above-described embodiments illustrate only exemplary applications and that a variety of other applications are possible by processing glass surfaces with an interference pattern of a CO2 laser as described herein.

It should be noted that an optical arrangement or an actuator arrangement as described herein is not limited to the decided entities as described in some embodiments. Rather, the items disclosed herein may be implemented in numerous ways while still providing the disclosed specific functionality.

It is noted that each entity disclosed herein (e.g., process steps, components, elements, arrangements, and devices) is not limited to a decided entity as described in some embodiments. Rather, the subject matter described herein may be provided in different ways with different granularity at the device level or process level while still providing the specified functionality. According to other embodiments, an entity may be configured to provide two or more functions as described herein. According to yet other embodiments, two or more entities may be configured to collectively provide a function as described herein.

A definition of an optical arrangement or an optical geometry with reference to a laser radiation can of course also be defined analogously with reference to a radiation path of the laser radiation, and vice versa. In this respect, any reference herein to a laser radiation analogously discloses a reference to a radiation path of the laser radiation.

It is noted that the embodiments described herein represent only a limited selection of possible embodiments of the present disclosure. Thus, it is possible to combine the features of different embodiments in a suitable manner, so that for those skilled in the art, a plurality of different embodiments are to be considered disclosed with the embodiments made explicit herein. Furthermore, it should be mentioned that terms such as “a” or “an” do not exclude a plurality. Terms such as “comprising” or “having” do not exclude further features or process steps. Consequently, according to an embodiment, the term “comprising” or “having” stands for “comprising, inter alia”. According to a further embodiment, the term “comprising” or “having” stands for “consisting of”, According to an embodiment, the term “adapted to” comprises among others the meaning “configured to”. It should also be noted that reference signs in the claims should not be construed as limiting the scope of the claims. It should further be noted that reference signs in the description and the description's reference to the drawings should not be construed as limiting the scope of the description. Rather, the drawings illustrate only an exemplary implementation of a particular combination of several embodiments of the subject matter disclosed herein, any other combination of embodiments being equally possible and to be considered disclosed by this application.

In summary, it remains to be stated:
Disclosed is a method comprising: generating an interference pattern on a glass surface to thereby process the glass surface, wherein the interference pattern is generated by a laser radiation of a CO2 laser. Further disclosed is a corresponding surface processing device and a corresponding use of an interference pattern of a CO2 laser.

1. A method comprising:
generating an interference pattern on a glass surface to thereby process the glass surface;
wherein the interference pattern is generated by a laser radiation of a CO2 laser.

2. The method according to claim 1, wherein adjacent intensity maxima of the interference pattern have a spacing that is in a range between 10 μm and 500 μm.

3. The method according to claim 1, wherein adjacent intensity maxima of the interference pattern have a spacing that is in a range between 50 μm and 150 μm.

4. The method according to claim 1, further comprising:
moving the glass surface and a beam path of the laser radiation, which terminates on the glass surface, relative to one another, wherein the interference pattern is generated on the glass surface at least temporarily during the moving.

5. The method according to claim 4, wherein the moving of the beam path and the glass surface relative to each other is performed in at least two directions that are linearly independent of each other.

6. The method according to claim 1, wherein the glass surface is a surface of a quartz glass or a borosilicate glass.

7. A surface processing device comprising:
an object receptacle for accommodating an object having a glass surface;
an optical arrangement for receiving laser radiation from a CO2 laser, the optical arrangement being adapted to generate an interference pattern on the glass surface from the laser radiation to thereby process the glass surface.

8. A method of using an interference pattern of a CO2 laser for changing a surface property of a glass surface.

9. The method of using according to claim 8, wherein the change in a surface property comprises at least one of the following:
a change in a contact angle of the glass surface with a liquid;
a change in an optical property of the glass surface.

10. The method of using according to claim 8, wherein the change in a surface property is an anisotropic change in a surface property.
